(19) United States
(12) Patent Application Publication
(10) Pub. No.: US 2014/0261148 A1
(43) Pub. Date: Sep. 18, 2014

(54) MAGNETIC FLAG HOLDER APPARATUS

(71) Applicant: Jacob HARARI, Brooklyn, NY (US)

(72) Inventor: Jacob HARARI, Brooklyn, NY (US)

(21) Appl. No.: 14/070,877

(22) Filed: Nov. 4, 2013

Related U.S. Application Data
(60) Provisional application No. 61/780,054, filed on Mar. 13, 2013.

(51) Int. Cl. G09F 17/00

(52) U.S. Cl. CPC G09F 17/00
USPC 116/173

(57) ABSTRACT

A flag assembly comprises a flag body with a holding end region and a strip shaped holder which is attached to the holding end region of the flag. The strip shaped holder is an elongated strip of material with a plurality of spaced magnet elements substantially embedded in the strip. The magnets are located close to the surface or flush with the surface of the holder at one end of the holder and are intended to be placed against the metallic surface to hold the flag body, for example, to an outer surface of a vehicle and maintain it attached even with if the vehicle travels at speeds as high as 70, 80 or even 100 miles per hour.

### CROSS REFERENCE TO RELATED APPLICATION

This application claims the benefit and priority of U.S. Provisional patent application Ser. No. 61/780,054 filed Mar. 13, 2013, entitled METHOD OF DISPLAYING FLAGS AND BANNERS ON VEHICLES, the entire disclosure of which is incorporated herein by reference.

### BACKGROUND OF THE INVENTION

The present invention generally relates to constructions and expedients to removably hold a flag to a surface, without a flagpole or any clamping or bolting or gluing securing arrangements.

More specifically, the present invention relates to a flag or banner holder usable with a car, bicycle or any vehicle or metallic surface, enabling the flag to be held in place without any hook or special securing apparatus. The holder of the present invention is capable of attaching a flag directly to a metallic surface without causing any damage or requiring any additional accessories, enabling the flag to be attached to even an exterior of a vehicle or a bicycle or a door and to withstand and hold itself connected to the vehicle, even when the vehicle travels at great speeds.

It will be understood by those skilled in the art that while the present invention has been specifically designed for use in connection with holding a flag, the use of the present invention can have numerous diverse applications, as is readily apparent from the present disclosure.

Heretofore, the prior art has described various constructions and implements for securing flags to various devices in a variety of ways, including using ropes, nails, screws, clamps, clips and the like.

The flag holders which are generally known in the prior art, have inherent disadvantages, including the lack of any means to connect them to a flat surface, without causing damage to the surface, and having structures more complicated and involved than necessary, increasing their costs. The prior art is exemplified by the descriptions in various United States patent publications, including in: 2003/0071185; 2003/0094470; 2003/0183739; 2003/0213425; and 2005/0108909. The contents of said United States patent publications are incorporated by reference herein.

### SUMMARY OF THE INVENTION

It is an object of the present invention to provide a unique apparatus to secure a flag on various surfaces.

It is a further object of the present invention to provide various means to hold the flag or a banner to a surface, in a manner which enables easy attachment and disattachment.

It is a further object of the present invention to provide an efficient and economic solution to the problem of keeping the flag or banner connected to a moving car or object.

The foregoing and other objects of the invention are realized by a flag holder which comprises a flag body with a holding end region and strip-shaped holder that is attached to the holding end region of the flag. The holder is elongated and strip-shaped and has along the length thereof, a plurality of spaced magnet elements that are substantially embedded in the body of the holder. Preferably, the holder is made of rubber with a plurality of openings for the magnets and mesh material inside the body of the holder to keep the magnets from falling out from the openings in which the magnets are located.

In accordance with other embodiments, the magnets are held in openings in magnet wells with constricted openings into which they are inserted and protected against falling out, or are embedded in a foam or rubber strip which is inserted into a sleeve of the flag body.

Other features and advantages of the present invention will become apparent from the following description of the invention which refers to the accompanying drawings.

### BRIEF DESCRIPTION OF THE DRAWINGS

FIG. 1 is a perspective of a prior art flag holder.

FIG. 2 is a perspective of the present invention in accordance with one embodiment thereof.

FIG. 2a shows one side of the flag holder of FIG. 2.

FIG. 2b shows the rear side of the flag holder.

FIG. 3a is a cross section through the flag holder of FIG. 2.

FIG. 3b is an alternative embodiment of FIG. 3a.

FIG. 3c is an alternative embodiment of FIG. 3a.

FIG. 3d is an alternative embodiment of FIG. 3a.

FIG. 3e shows a modification of the embodiment of FIG. 3a.

FIG. 4 shows the top, bottom and side views for the embodiment of FIG. 3d.

### DETAILED DESCRIPTION OF THE DRAWINGS

In the perspective of Prior Art FIG. 1, the American flag 10 has at its right side end region, a sleeve 12 with a bottom opening 14 and a closed top 15. The pole 16 (shown separately) can be inserted through the opening 14, with the pole bottom end 17, including a securing mechanism (not shown) for securing the flag to an object, for example, to a car or to a table and the like, by conventional means, such as by clamp, clip, bolt, screw and the like.

Referring to FIG. 2, the flag or banner 20 is provided, in place of the sleeve of FIG. 1, with a holder 22, that comprises a long strip which is folded over with the edge of the flag 22 held therebetween, the holder being either sewn or glued to the end edge of the flag 20. Internally, the strip 22 is provided with several spaced magnets 30, which are visible at one side thereof through several openings 23. In a preferred embodiment, the holder 22 is made of folded over or slit rubber strip, which has a thickened edge 22a (FIG. 2a). The opposed side of the holding strip 22a is flat and closed, as shown in FIG. 2b.

Referring to FIG. 3a, which is a cross-section through the strip 22 of FIG. 2, note that the strip material has the thickened portion 22a, with a slit 22d formed within the body of the rubberized sheath, providing one side of the sheath as 22b and another side of the sheath as 22c. At spaced intervals, cavities 25 are cut into the bottom sheath 22c and a screen material 24 runs through the slit 22d and around each of the magnets 30, holding the magnets from falling out of the cavities. The flag edge (not shown in FIG. 3a) fits in the slit 22d and is held in place, including the screen material and by either a glue, or possibly by the sheath material 22b and 22c being sewn together at the edge, the threads passing through the flag.

In a modified embodiment, the screen material or web 24 is dispensed with and instead of providing through going openings 25, the magnet 30 is located in a cup local space 27 in which the magnet is held with the magnet exerting its magnetic force through the thin skin 29 of the sheath material 22c, below the cup 27 which has a thickness of only 1/32^{nd} of an inch. The thin skin does not unduly space the magnets 30 away from the metallic car surface to which the magnets are to be attracted in use.

In the embodiment of FIG. 3c, the magnets 30 are squeezed into openings that are slightly undersized, holding the magnets in place. The magnets will not dislodge, because the entire sheath material is inserted into the sleeve 12 of the flag.

Lastly, in the embodiment of FIG. 3d, the magnets are inserted into a foam or rubber strip 50 and the foam or rubber strip 50 is inserted into the sleeve 12 of the flag 10 (which is shown partially cut away). The strip 50 has folded over the tabs 52a, 52b at opposed ends that sandwich the material of the flag sleeve 12 and are preferably glued or sewn or otherwise attached to it. As before, the foam strip 50 has openings 54 accommodating the cylindrical magnets 56. The openings 54 may be provided on the opposed side of the foam strip 50.

FIG. 3e shows the holder of FIG. 3a but with a concave region 32 located behind the leading projection 32a of the holder 22, to create a high-pressure area on the top as the vehicle is in motion.

As before, the bottom portion of the strip is perforated to accommodate the small magnets 30 whose pull force attaches the holder to the vehicle or other metal object. As noted previously, the magnets are held in place buy the use of mesh screen, or the sleeve of the flag, coming in direct contact with the metal to which it is being attached directly to the outside of the vehicle.

The two, upper and bottom portions of the strip holder, are brought together by means of adhesive or by a “zip lock” construction of the holder. The zip lock closing makes it possible to interchange the flag or the banner being used, as desired.

The prior reference to a foam element can be implanted with small round “BB” magnets spaced within, which are inserted in the sleeve of the flag, as previously described. The assembly is attached to the door of the vehicle. The door of the vehicle is then closed, holding the assembly in place while the vehicle is in motion. Interchangeability of the flag, using the same element, is then possible by removing the element and placing it in a different flag or banner. The foam element, being soft, and the small BB magnets being miniscule, allow the vehicle door to be closed, to hold the assembly in place.

In accordance with the alternative of using a thin rubber element, with small magnets nested within, the rubber element is similarly inserted in the sleeve of the flag and attached magnetically, resting entirely on the outside of the vehicle. The “nose” shape of the element as shown in FIG. 3e, is conducive to causing the air to rush over the assembly. With this embodiment as weel, interchangeability of the flag is possible by removing and replacing the rubber element or strip in a different flag or banner.

The magnetic flag holder apparatus described above is not limited to rectangular shaped flags, but may be also be applied and used with pennants and bunting flags as well. Similarly, the use of the flag holder is not limited to being used with moving vehicles and the like, as it may be used to attach flags, banners and the like to any metallized structure, including front doors, windows with metal frames, light poles, etc. Further, although the strip holder is shown extending on a straight line, it is within the ambit of the invention that it can be somewhat arcuate for specific purposes, as when supporting a plurality of adjacently located ribbons, or the like.

Relative to the foregoing description of the invention, certain observations can be made, including:
A. A rubber or similar material is used, where the magnets are secured to the bottom of the assembly by means of a mesh fabric. The flag is sewn onto the mesh fabric. The rubber-holding strip is punched all the way through.
B. A rubber or similar material is used where the magnets are secured within a “cup” molded within the bottom of the element. The rubber is not punched all the way through.
C. A rubber or similar material is used where the magnets are secured within the sleeve of the flag (the sleeve is where the flagstick would usually go). The rubber is punched all the way through.
D. A foam tube is inserted within the sleeve of the flag, having small magnetic pellets within. The flag would then be positioned on the inside door well of the car, then the door would be shut to hold the flag in place while the vehicle is in motion.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A flag assembly, comprising:
a flag body including a holding end region;
a strip shaped holder attached to the holding end region of the flag and extending substantially along a length dimension of the holding edge and comprising a series of space magnet elements substantially embedded in the holder.

2. The flag assembly of claim 1, wherein the holder is made of one of: rubber, foam and plastic material.

3. The flag assembly of claim 2, the holder including a plurality of openings for the magnets and a mesh material inside the body of the holder preventing the magnets from falling out.

4. The flag assembly of claim 2, wherein the magnets located in magnet wells in the holder and the magnets are sealed inside the holder with a thin web of the strip material separating the magnet from the metallic surface to which it is to be attached.

5. The flag assembly of claim 1, wherein the flag comprises a closed sleeve attached at the end region and the holder is inserted inside the flag sleeve.

6. The flag assembly of claim 2, wherein the holder is comprised of foam material with the magnets spacedly inserted thereinto and the flag comprises a sleeve in which the foam strip is receivable.

7. The flag assembly of claim 1, wherein the holder is sewn to the holding end region of the flag body.

8. The flag assembly of claim 1, wherein the holder is glued to the holding end region of the flag body.

9. The flag assembly of claim 1, wherein the holder comprises a thickened region by which the holder can grasped and pulled away from a metallic surface to which it magnetically adheres.

10. The flag assembly of claim 1, in combination with an American flag.

11. The flag assembly of claim 1, in combination with a bunting flag.

12. The flag assembly of claim 9, wherein the holder comprises a leading end with a concavity formed at the leading end to develop an air pressure that exerts a force that holds the holder to the metallic surface against which it is placed.

13. The flag assembly of claim 1, wherein the magnets are miniscule BB magnets.

14. The flag assembly of claim 1, wherein the holder is made of foam material and is configured to be located in the space of a door of a vehicle and to allow the door to be closed unto and receive the holder.
